(19) United States
(12) Patent Application Publication
(10) Pub. No.: US 2013/0248676 A1
(43) Pub. Date: Sep. 26, 2013

(54) SUPPORTING COMPONENT

(71) Applicant: INVENTEC CORPORATION, Taipei (TW)

(72) Inventors: Shih-Hsuan Wang, Taipei (TW); Ming-Hsien Hsu, Taipei (TW)

(73) Assignee: INVENTEC CORPORATION, Taipei (TW)

(21) Appl. No.: 13/803,096

(22) Filed: Mar. 14, 2013

(30) Foreign Application Priority Data
Mar. 21, 2012 (TW) 101109757

(51) Int. Cl. F16M 11/20

(52) U.S. Cl. CPC F16M 11/2021
USPC 248/462

(57) ABSTRACT

A supporting component comprising a bottom base, a top base, a supporting plate, and a supporting unit is disclosed. An accommodating groove is at a lateral surface of the bottom base. The top base is pivottably connected to the bottom base around a first pivot. The bottom base is movably disposed at the accommodating groove. The supporting unit is pivottably connected to the top base around a second pivot, and the supporting unit is pivottably connected to the supporting plate around a third pivot. When the top base pivots around the first pivot from a closing position to an opening position, the top base pushes the supporting unit so that the supporting unit pushes the supporting plate to stick out from the accommodating groove. Therefore, the supporting component is at a supporting state automatically.

### CROSS-REFERENCE TO RELATED APPLICATIONS

This non-provisional application claims priority under 35 U.S.C. §119(a) on Patent Application No(s). 101109757 filed in Taiwan, R.O.C. on Mar. 21, 2012, the entire contents of which are hereby incorporated by reference.

### BACKGROUND OF THE INVENTION

1. Technical Field of the Invention

The disclosure relates to a supporting component, and more particularly, to a supporting component of a mobile device.

2. Description of the Related Art

In recent years, portable electronic devices have become more and more popular. For example, designs for portable electronic devices, such as notebooks, tablet computers or smart phones connecting with external keyboards, have been well developed. When using a portable electronic device including an input device, such as a keyboard, a user usually lifts up the screen of the portable electronic device, and then gives the portable electronic device commands by the input device on the base of the portable electronic device, such as a keyboard. Usually, the screen is pivotabbly connected to the base around the edge. However, for visual considerations (i.e. convenience), the screen is lifted up from the base by an angle greater than 90 degrees. Therefore, the orthographic projection of the center of gravity of the screen is beyond the base. As the notebooks have become lighter, the notebooks are more likely to topple over because the screens of the notebooks have not been lightened. When the user uses a tablet computer with a base including a keyboard, the tablet computer is more likely to topple over because the tablet computer is usually heavier than the base including a keyboard. Therefore, it is not user-friendly and safety considerations have derived.

According to the above problems, some portable electronic devices further include a bracket, and the bracket supports the screen, so that the center of gravity is on the base. Therefore, the problem that the portable electronic devices topple over because the center of gravity is beyond the base is avoided. However, the center of gravity is usually at the central section of a matter. When the user considers keeping the orthographic projection of the center of gravity of the screen in the base, then part of the screen covers the base, so that the part of the base covered by the screen can not be used. Also, when lifting the screen, the user usually needs to spend extra time to adjust the bracket so as to keep the center of gravity in the base. Therefore, how to avoid the screen from toppling over and to support the screen immediately, have become the problems needed to be solved in the filed of the corresponding electronic devices.

### SUMMARY OF THE INVENTION

According to an embodiment, a supporting component comprising a bottom base, a top base, a supporting plate, and a supporting unit is disclosed. A lateral surface of the bottom base includes an accommodating groove. The top base is pivotabbly connected to the lateral surface of the bottom base around a first pivot. The supporting plate is movably disposed at the accommodating groove. The supporting unit is pivotabbly connected to the top base around a second pivot, and the supporting unit is pivotabbly connected to the supporting plate around a third pivot. The top base is at a closing position when the top base approaches the bottom base. The top base is at an opening position when the top base deviates from the bottom base. When the top base pivots around the first pivot from the closing position to the opening position, the top base pushes the supporting unit so as to push the supporting plate, so that the supporting plate sticks out from the accommodating groove.

### BRIEF DESCRIPTION OF THE DRAWINGS

The present disclosure will become more fully understood from the detailed description given herein below for illustration only, and thus does not limit the present disclosure, wherein:

FIG. 1A is a schematic perspective view of a supporting component clamping a mobile device when a top base is at a closing position according to an embodiment of the disclosure;

FIG. 1B is a schematic perspective view of a supporting component separating from a mobile device according to an embodiment of the disclosure;

FIG. 1C is an exploded perspective view of a supporting component according to an embodiment of the disclosure;

FIG. 1D is a sectional view of the supporting component in FIG. 1A when the top base is at an opening position;

FIG. 2 is a schematic perspective view of a supporting component clamping a mobile device when a top base is at a closing position according to another embodiment of the disclosure;

FIG. 3A is a schematic perspective view of a supporting component clamping a mobile device when a top base is at a closing position according to another embodiment of the disclosure;

FIG. 3B is a sectional view of the supporting component in FIG. 3A when the top base is at an opening position;

FIG. 4A is a schematic perspective view of a supporting component clamping a mobile device when a top base is at a closing position according to another embodiment of the disclosure;

FIG. 4B is an exploded perspective view of a supporting component according to another embodiment of the disclosure;

FIG. 4C is a sectional view of the supporting component in FIG. 4A when the top base is at the closing position;

FIGS. 4D to 4F are sectional views of the supporting component in FIG. 4C during the process of the supporting component moving from the closing position to opening position;

FIG. 5 is a schematic perspective view of a supporting component clamping a mobile device when a top base is at a closing position according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

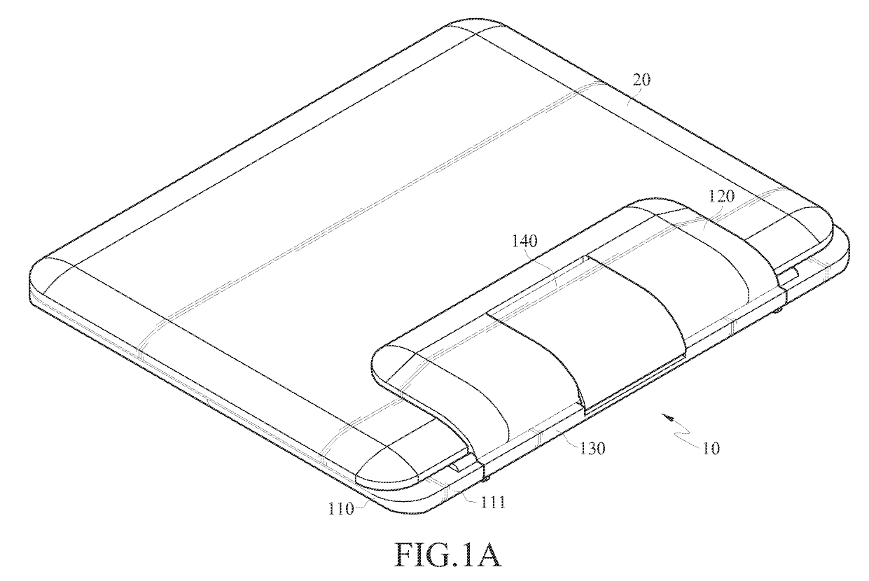

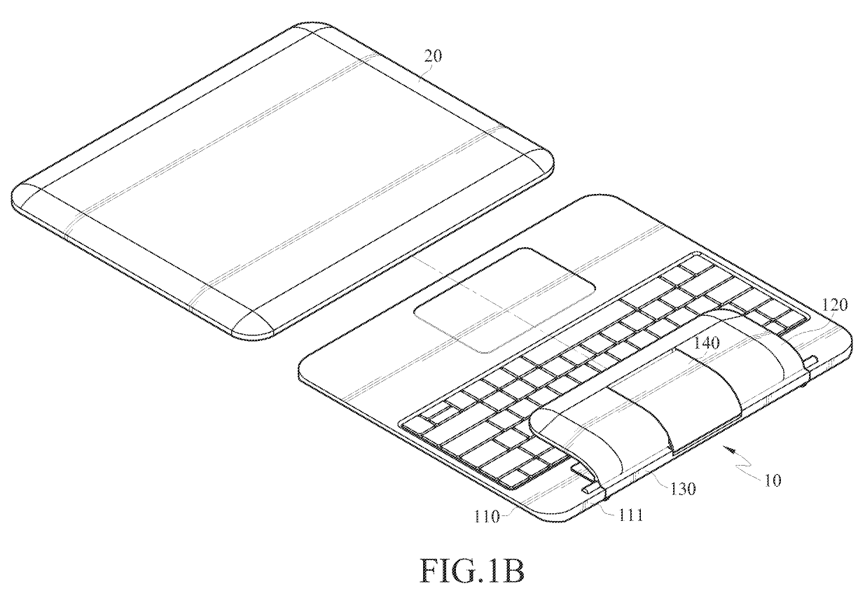

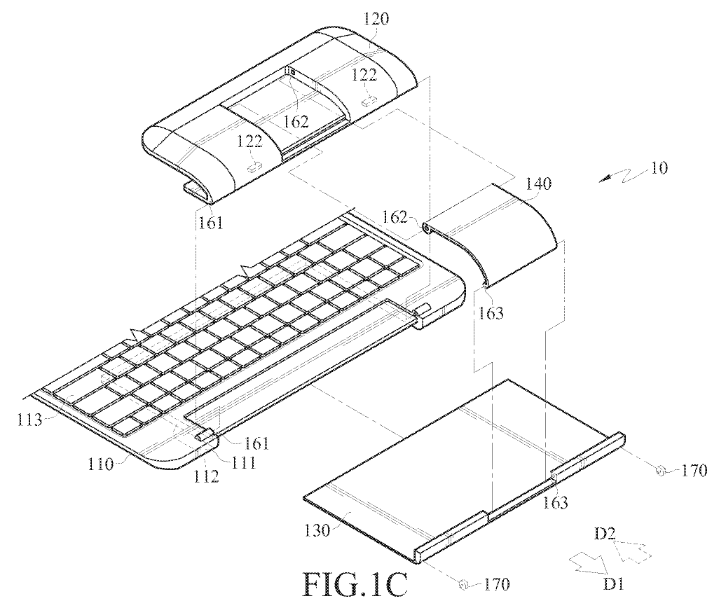

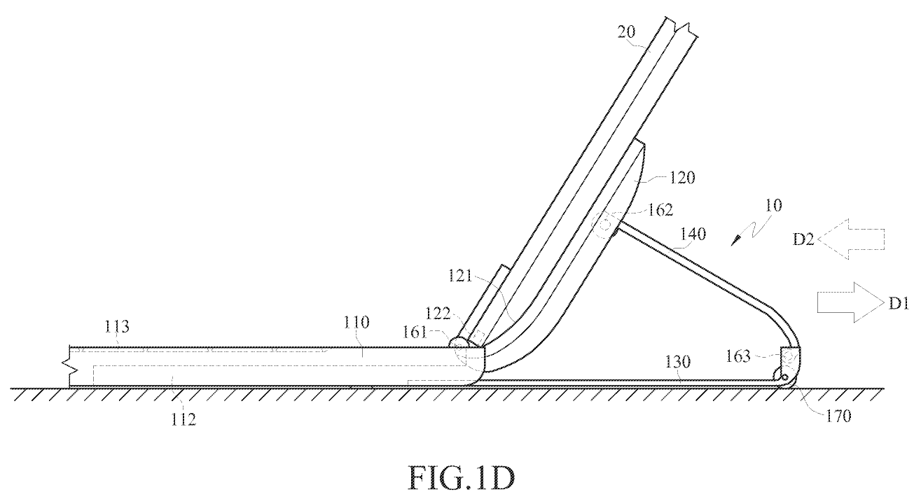

Please refer to FIG. 1A. FIG. 1A is a schematic perspective view of a supporting component 10 clamping a mobile device 20 when a top base is at a closing position according to an embodiment of the disclosure. The mobile device 20 is, for example, a tablet computer or a smart phone. Please refer to FIG. 1B. FIG. 1B is a schematic perspective view of a supporting component 10 separating from a mobile device according to an embodiment of the disclosure. The supporting component 10 comprises a bottom base 110, a top base 120, a supporting plate 130, and a supporting unit 140. Please refer to FIG. 1C. FIG. 1C is an exploded perspective view of a supporting component 10 according to an embodiment of the disclosure. The bottom base 110 includes a lateral surface 111. The lateral surface 111 includes an accommodating groove 112. The top base 120 is pivottably connected to the lateral surface 111 of the bottom base 110 by a first pivot 161. The supporting plate 130 is movably disposed at the accommodating groove 112. Therefore, the supporting plate 130 sticks out from the accommodating groove 112 along a drawing direction Dl or the supporting plate 130 embeds into the accommodating groove 112 along an inserting direction D2. The drawing direction Dl is opposite to the inserting direction D2. The supporting unit 140 is pivottably connected to the top base 120 by a second pivot 162. The first pivot 161 and the second pivot 162 are kept apart by a distance, so that the first pivot 161 and the second pivot 162 are not coaxial. The supporting unit 140 is pivottably connected to the supporting plate 130 by a third pivot 163.

In this embodiment, the shape of the supporting unit 140 is plane-like, but the shape of the supporting unit 140 is not to limit to the invention. In this and some other embodiments, the supporting component 10 further comprises two wheels 170, but the invention is not limited thereto. In other embodiments, the supporting component 10 comprises a single wheel or the supporting component 10 comprises multiple wheels. In this embodiment, the two wheels 170 are disposed at the supporting plate 130. The axial direction of the two wheels 170 are perpendicular to the drawing direction Dl and the inserting direction D2, so that the movement of the two wheels 170 in the accommodating groove 112 along the drawing direction D1 and the inserting direction D2 is satisfied. In this embodiment, the bottom base 110 includes an input device 113. The input device 113 is, for instance, a keyboard.

Please refer to FIG. 1D. FIG. 1D is a sectional view of the supporting component 10 in FIG. 1A when the top base 120 is at an opening position. In this embodiment, the top base 120 includes a clamping space 121 so that the mobile device 20 is able to be disposed at the supporting component 10. The top base 120 includes a connecting port 122 in the clamping space 121. Therefore, when the supporting component 10 connects to the mobile device 20, the input device 113 of the supporting component 10 is able to transmit the signals to the mobile device 20.

As shown in FIG. 1D, when the mobile device 20 is lifted up, the top base 120 pivots around the first pivot 161 clockwise from the closing position approaching the bottom base 110 so as to deviate from the bottom base 110. The top base 120 pushes the supporting unit 140 toward a right direction by the second pivot 162. The supporting unit 140 pushes the supporting plate 130 toward a right direction by the third pivot 163, so that the supporting plate 130 sticks out from the accommodating groove 112 along the drawing direction Dl. When the distance that the supporting plate 130 sticking out from the accommodating groove 112 reaches a maximum, the supporting plate 130 can not move toward a right direction anymore. Therefore, the supporting plate 130 of the supporting component 10 restricts the movement of the supporting unit 140 by the third pivot 163, so that the supporting unit 140 supports the top base 120, and the top base 120 does not further rotate clockwise. In other embodiments, the top base 120 restricts the rotation of the second pivot 162, so that the supporting unit 140 can not rotate counterclockwise, as well as the supporting unit 140 supports the top base 120 and the top base 120 does not further rotate clockwise.

Therefore, as a user lifts up the top base 120, the top base 120 moves from the closing position to the opening position being supported by the supporting unit 140 automatically. Also, the orthographic projection of the top base 120 is not on the bottom base 110, so that there is more space in the bottom base 110 for the user's usage. Therefore, it becomes more convenient.

When the user considers moving the top base 120 from the opening position (as shown in FIG. 1D) to the closing position, the user closes the mobile device 20, so that the top base 120 pivots around the first pivot 161. The top base 120 drives the supporting unit 140 moving by the second pivot 162, and the top base 120 drives the supporting plate 130 moving along the inserting direction D2 by the third pivot 163, so that the supporting plate 130 embeds into the accommodating groove 112 gradually. When the top base 120 approaches the bottom base 110 (as shown in FIG. 1A), the supporting plate 130 substantially and fully embeds into the accommodating groove 112, as well as the top base 120 is at the closing position. Therefore, when the user closes the top base 120, the top base 120 moves from the opening position to the closing position automatically, so that further manipulations are not required.

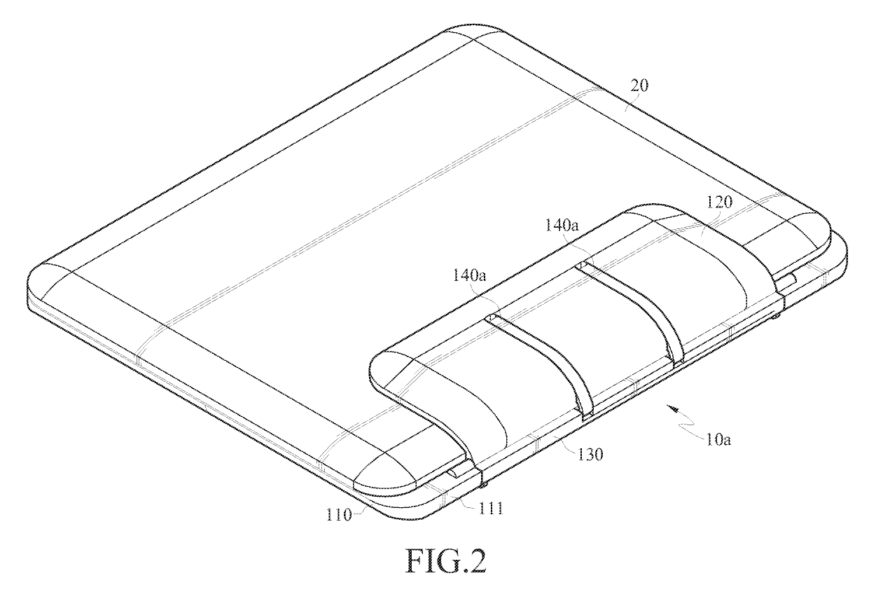

Please refer to FIG. 2. FIG. 2 is a schematic perspective view of a supporting component 10a clamping a mobile device 20 when a top base is at a closing position according to another embodiment of the disclosure. In this embodiment, the supporting component 10a is similar to the supporting component 10 in FIG. 1A. In this embodiment, the shape of a supporting unit 140a is pillar-like, and the number of the supporting units 140a is two, but the invention is not limited thereto. In other embodiments, the number of the supporting units 140a is one or greater than two.

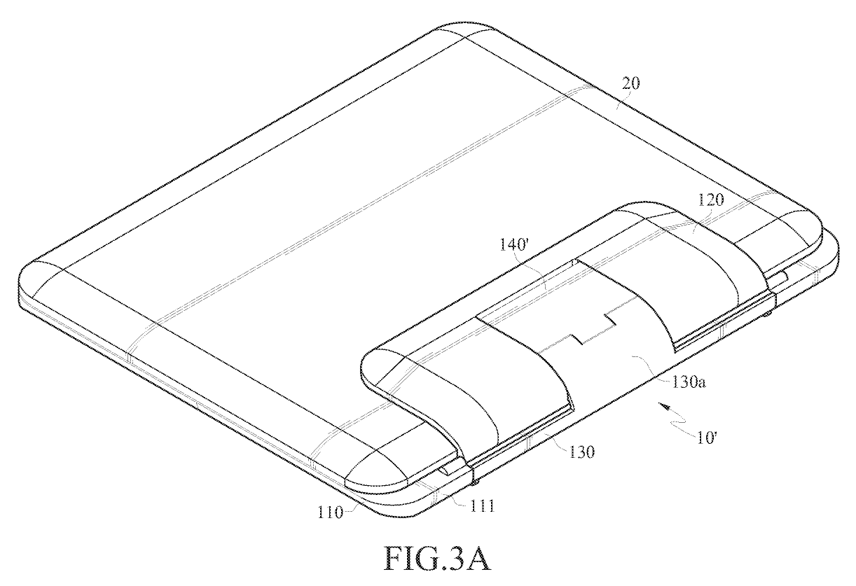

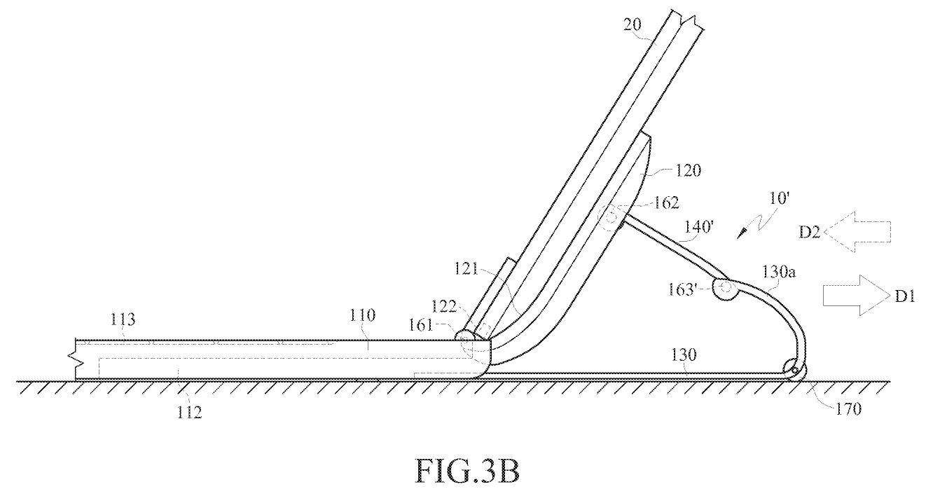

Please refer to FIGS. 3A and 3B. FIG. 3A is a schematic perspective view of a supporting component 10′ clamping a mobile device 20 when a top base 120 is at a closing position according to another embodiment of the disclosure, and FIG. 3B is a sectional view of the supporting component 10′ in FIG. 3A when the top base 120 is at an opening position. In this embodiment, the supporting component 10′ comprises a bottom base 110, a top base 120, a supporting plate 130, and a supporting unit 140′. In this embodiment, the supporting plate 130 further includes an extending portion 130a. When the top base 120 is at the closing position, part of the bottom base 110 and the top base 120 are between the extending portion 130a and the supporting plate 130. The supporting unit 140′ is pivottably connected to the extending portion 130a by the third pivot 163′. The shape of the supporting unit 140′ is, for example, plane-like, but the invention is not limited thereto. In other embodiments, the shape of the supporting unit 140′ is pillar-like.

As shown FIG. 3B, when the mobile device 20 is lifted up, the top base 120 pivots around the first pivot 161 clockwise from the closing position approaching the bottom base 120 so as to deviate from the bottom base 110. The top base 120 pushes the supporting unit 140′ toward a right direction by the second pivot 162. The supporting unit 140′ pushes the extending portion 130a of the supporting plate 130 toward a right direction by the third pivot 163′, so that the supporting plate 130 sticks out from the accommodating groove 112 along the drawing direction Dl. When the distance that the supporting plate 130 sticking out from the accommodating groove 112 reaches a maximum, the supporting plate 130 can not further move toward a right direction. Therefore, the supporting plate 130 of the supporting component 10′ restricts the movement of the supporting unit 140′ by the extending portion 130a and the third pivot 163′, so that the supporting unit 140′ supports the top base 120, and the top base 120 does not further rotate clockwise. In other embodiments, the top base 120 restricts the rotation of the second pivot 162, so that the supporting unit 140′ does not further rotate counterclockwise, as well as the supporting unit 140′ supports the top base 120 and the top base 120 does not further rotate clockwise.

Therefore, as a user lifts up the top base 120, the top base 120 moves from the closing position to the opening position being supported by the supporting unit 140′ automatically. Also, the orthographic projection of the top base 120 is not on the bottom base 110, so that there is more space in the bottom base 110 for the user's usage. Therefore, it becomes more convenient.

When the user consider to move the top base 120 from the opening position (as shown in FIG. 3B) to the closing position, the user closes the mobile device 20, so that the top base 120 pivots around the first pivot 161 counterclockwise. The top base 120 drives the supporting unit 140′ moving by the second pivot 162, and the top base 120 drives the extending portion 130a moving by the third pivot 163, so that the supporting plate 130 moves along the inserting direction D2 and the supporting plate 130 embeds into the accommodating groove 112 gradually. When the top base 120 approaches the bottom base 110 (as shown in FIG. 3A), the supporting plate 130 substantially and fully embeds into the accommodating groove 112, as well as the top base 120 is at the closing position. Therefore, when the user closes the top base 120, the top base 120 moves from the opening position to the closing position automatically, so that further manipulations are not required.

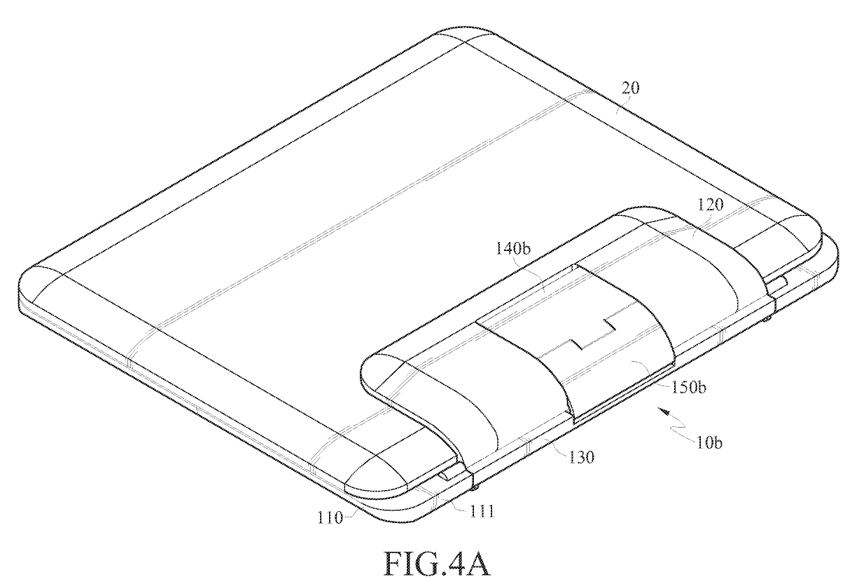

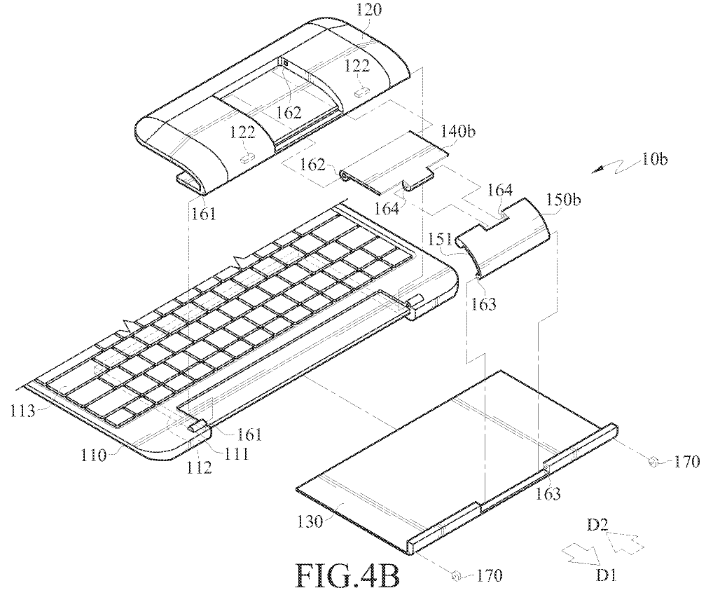

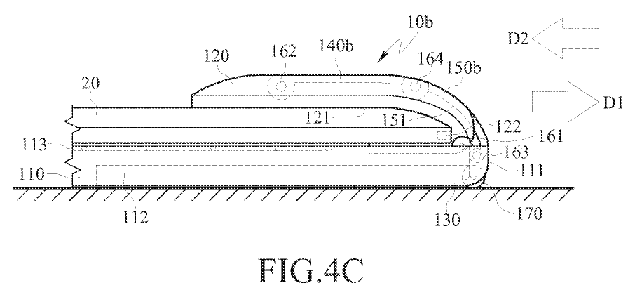

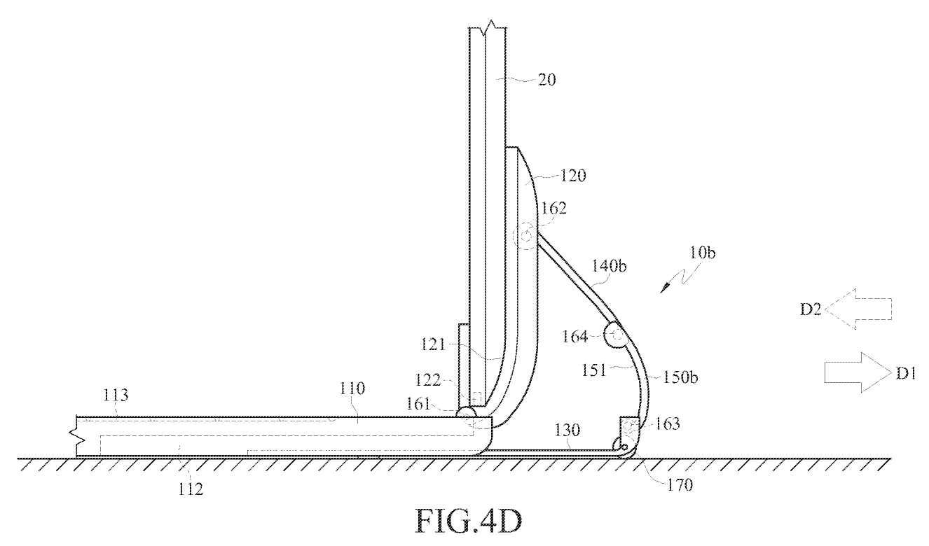

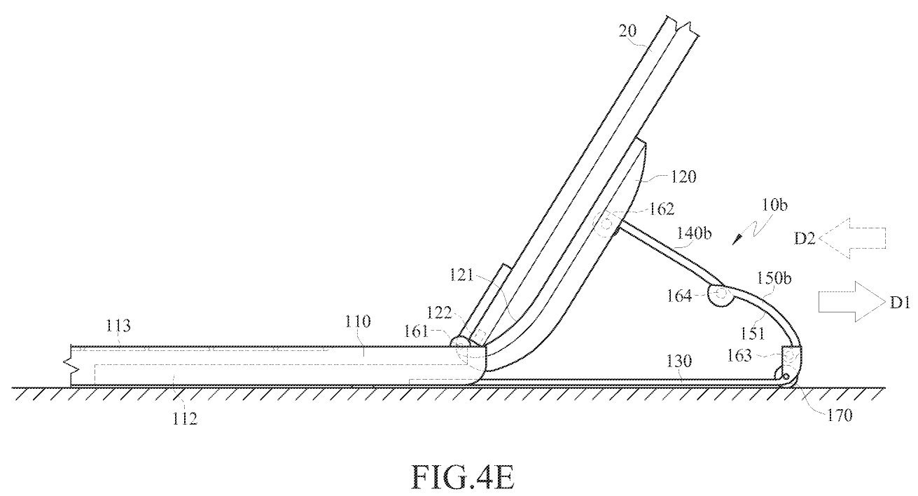

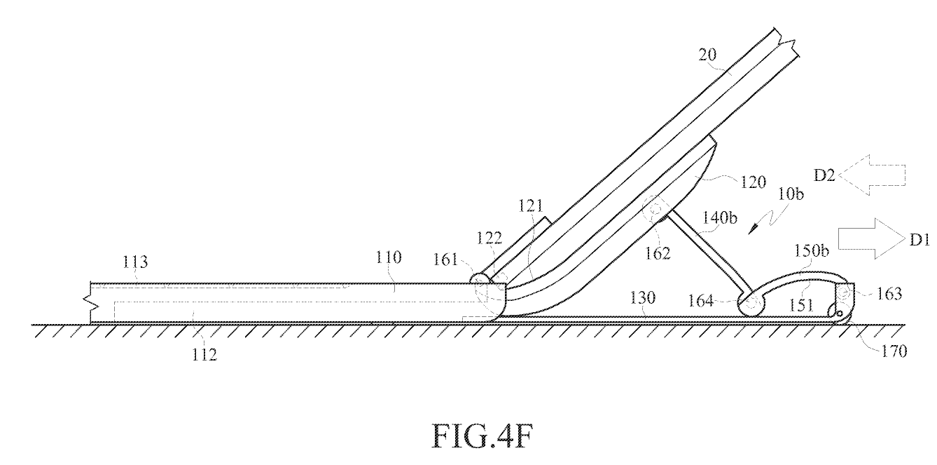

Please refer to FIG. 4A. FIG. 4A is a schematic perspective view of a supporting component 10b clamping a mobile device 20 when a top base is at a closing position according to another embodiment of the disclosure. The supporting component 10b comprises a bottom base 110, a top base 120, a supporting plate 130, a first supporting unit 140b, and a second supporting unit 150b. Please refer to FIG. 4B. FIG. 4B is an exploded perspective view of a supporting component 10b according to another embodiment of the disclosure. The bottom base 110 includes a lateral surface 111. The lateral surface 111 includes an accommodating groove 112. The top base 120 is pivottably connected to the lateral surface 111 of the bottom base 110 by a first pivot 161. The supporting plate 130 is movably disposed at the accommodating groove 112. Therefore, the supporting plate 130 sticks out from the accommodating groove 112 along a drawing direction Dl or the supporting plate 130 embeds into the accommodating groove 112 along an inserting direction D2. The drawing direction Dl is opposite to the inserting direction D2. The first supporting unit 140b is pivottably connected to the top base 120 by a second pivot 162. The first pivot 161 and the second pivot 162 are kept apart by a distance, so that the first pivot 161 and the second pivot 162 are not coaxial. The second supporting unit 150b is pivottably connected to the supporting plate 130 by a third pivot 163. Also, the second supporting unit 150b is pivottably connected to the first supporting unit 140b by a fourth pivot 164.

In this embodiment, the supporting component 10b further comprises two wheels 170, but the invention is not limited thereto. In other embodiments, the supporting component 10b comprises a single wheel or the supporting component 10b comprises multiple wheels. In this embodiment, the two wheels 170 are disposed at the supporting plate 130. The axial of the two wheels 170 are perpendicular to the drawing direction Dl and the inserting direction D2, so that the movement of the two wheels 170 in the accommodating groove 112 along the drawing direction D1 and the inserting direction D2 is satisfied. In this embodiment, the bottom base 110 includes an input device 113. The input device 113 is, but not limited to, a keyboard.

Please refer to FIG. 4C. FIG. 4C is a sectional view of the supporting component 10b in FIG. 4A when the top base is at the closing position. In this embodiment, the second supporting unit 150b includes a concave surface 151. The concave surface 151 of the second supporting unit 150b faces the first pivot 161 when the top base 120 is at the closing position. The top base 120 includes a clamping space 121 so that the supporting component 10b is able to clamp the mobile device 20. The top base 120 includes a connecting port 122 in the clamping space 121. Therefore, when the supporting component 10b connects to the mobile device 20, the input device 113 of the supporting component 10b is able to transmit the signals to the mobile device 20.

Please refer to FIG. 4D to 4F. FIGS. 4D to 4F are sectional views of the supporting component 10b in FIG. 4C during the process of the supporting component 10b moving from the closing position to opening position. As shown in FIG. 4D, when the mobile device 20 is lifted up, the top base 120 pivots around the first pivot 161 clockwise from the closing position approaching the bottom base 110 so as to deviate from the bottom base 110. At this moment, the included angle between the top base 120 and the bottom base 110 is roughly 90 degrees. The top base 120 pushes the first supporting unit 140b toward a right direction by the second pivot 162. The first supporting unit 140b drives the second supporting unit 150b moving by the fourth pivot 164, and the first supporting unit 140b pushes the supporting plate 130 toward a right direction by the third pivot 163, so that the supporting plate 130 sticks out from the accommodating groove 112 along the drawing direction D1.

As shown in FIG. 4E, when the top base 120 further pivots around the first pivot 161 clockwise (as shown in FIG. 4E) deviating from the bottom base 110, the included angle between the top base 120 and the bottom base 110 is roughly 120 degrees. The top base 120 pushes the first supporting unit 140b toward a right direction by the second pivot 162. Also, the fourth pivot 164 moves toward the supporting plate 130 so as to bend the included angle between the first supporting unit 140b and the second supporting unit 150b, so that the first supporting unit 140b rotates clockwise, and the second supporting unit 150b rotates counterclockwise. Therefore, the second supporting unit 150b pushes the supporting plate 130 toward a right direction by the third pivot 163, so that the supporting plate 130 moves along the drawing direction D1 and the supporting plate 130 sticks out from the accommodating groove 112.

As shown in FIG. 4F, when the top base 120 further pivots around the first pivot 161 clockwise deviating from the bottom base 110, the included angle between the top base 120 and the bottom base is roughly 140 degrees. The top base 120 pushes the first supporting unit 140b toward a lower right direction by the second pivot 162, and the top base 120 pushes the fourth pivot 164 toward a down direction, so that the fourth pivot 164 further moves toward the supporting plate 130 until the fourth pivot 164 leans against the supporting plate 130. At this moment, the top base 120 is at the opening position. The concave surface 151 of the second supporting unit 150b faces the supporting plate 130 when the top base 120 is at the opening position. When the distance that the supporting plate 130 sticking out from the accommodating groove 112 reaches a maximum, the supporting plate 130 cannot move toward a right direction anymore. Therefore, the first supporting unit 140b of the supporting component 10b supports the top base 120 by the fourth pivot 164 leaning against the supporting plate 130, so that the top base 120 does not further rotate clockwise. In other embodiments, the top base 120 restricts the rotation of the second pivot 162, so that the first supporting unit 140b does not rotate counterclockwise. Moreover, the first supporting unit 140b supports the top base 120, so that the top base 120 does not further rotate clockwise.

Therefore, the user only needs to lift up the top base 120, the top base 120 moves from the closing position to the opening position being supported by the first supporting unit 140b. Also, the orthographic projection of the top base 120 is not on the bottom base 110 so that there is more space in the bottom base 110 for the user's usage. Therefore, it becomes more convenient.

When the user consider to move the top base 120 from the opening position (as shown in FIG. 4F) to the closing position, the user closes the mobile deice 20, so that the top base 120 pivots around the first pivot 161 counterclockwise. The top base 120 drives the first supporting unit 140b moving by the second pivot 162, and the top base 120 drives the second supporting unit 150b moving by the fourth pivot 164, so that the fourth pivot 164 deviates from the supporting plate 130 gradually. As shown in FIG. 4E, while the top base 120 pivots further around the first pivot 161 counterclockwise, the included angle between the first supporting unit 140b and the second supporting unit 150 is smaller, so that the second supporting unit 150b drives the supporting plate 130 moving along the inserting direction D2 by the third pivot 163, and the supporting plate 130 embeds into the accommodating groove 112 gradually. As shown in FIG. 4D, when the top base 120 further pivots around the first pivot 161 counterclockwise, the top base 120 drives the first supporting unit 140b and the second supporting unit 150b moving, so that the supporting plate 130 embeds into the accommodating groove 112. When the top base 120 approaches the bottom base 110 (as shown in FIG. 4C), the supporting plate 130 is substantially and fully embeded into the accommodating groove 112, as well as the top base 120 is at the closing position.

Therefore, when the user closes the top base 120, the top base 120 moves from the opening position to the closing position automatically, so that further manipulations are not required.

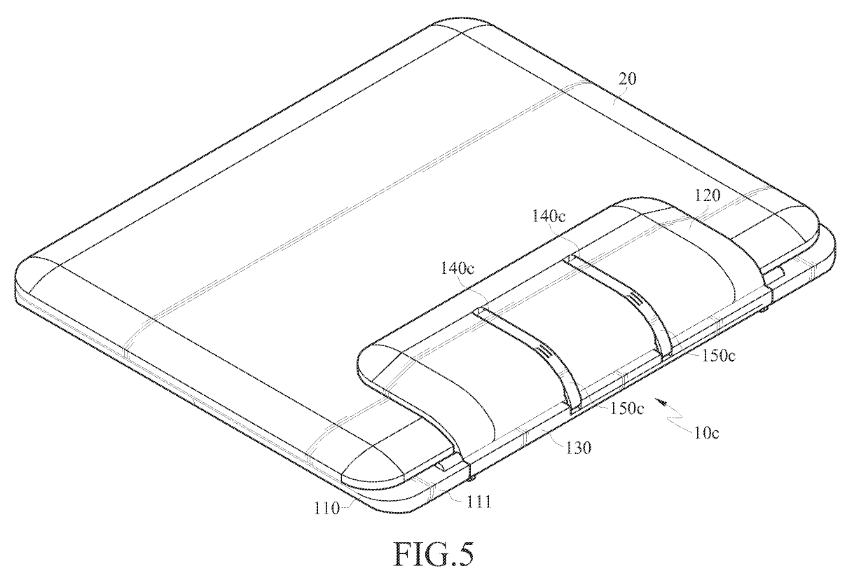

Please refer to FIG. 5. FIG. 5 is a schematic perspective view of a supporting component 10c clamping a mobile device 20 when a top base 120 is at a closing position according to another embodiment of the disclosure. In this embodiment, the supporting component 10c is similar to the supporting component 10c in FIG. 4A. In this embodiment, the supporting component 10c is similar to the supporting component 10b in FIG. 4A. However, in the embodiment, the shapes of the first supporting unit 140c and the second supporting unit 150c are pillar-like, and the numbers of the first supporting unit 140c and the second supporting unit 150c are relatively two, but the invention is not limited thereto. In other embodiments, the numbers of the first supporting unit 140c and the second supporting unit 150c are one or greater than two.

According to the embodiments of the disclosure, the top base drives the supporting plate moving from the accommodating groove. Therefore, when the top base is at the closing position, the user only needs to lift up the top base, and then the top base moves from the closing position to the opening position being supported by the supporting unit automatically. Also, the top base is pivottably connected to the lateral surface of the bottom base, so that the orthographic projection of the top base is not on the bottom base. Therefore, there is more space in the bottom base for the user's usage and it becomes more convenient. When the top base is at the opening position, the user only needs to close the top base, and then the supporting component drives the supporting plate embedding into the accommodating groove, so that the top base moves from the opening position to the closing position automatically, as well as further manipulations are not required.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A supporting component, comprising:
a bottom base, including a lateral surface, the lateral surface including an accommodating groove;
a top base, used for disposing a mobile device, the top base being pivottably connected to the lateral surface of the bottom base by a first pivot;
a supporting plate, movably disposed at the accommodating groove; and
a supporting unit, pivottably connected to the top base by a second pivot, the first pivot and the second pivot being kept apart by a distance, and the supporting unit being pivottably connected to the supporting plate by a third pivot;
wherein, when the top base pivots around the first pivot from a closing position approaching the bottom base to an opening position deviating from the bottom base, the top base pushes the supporting unit so that the supporting plate sticks out from the accommodating groove along a drawing direction.

2. The supporting component according to claim 1, further comprising at least a wheel, the wheel being disposed at the supporting plate.

3. The supporting component according to claim 2, wherein the axis of the wheel is perpendicular to the drawing direction.

4. The supporting component according to claim 1, wherein the top base includes a clamping space.

5. The supporting component according to claim 4, wherein the top base includes a connecting port and the connecting port is in the clamping space.

6. The supporting component according to claim 1, wherein the bottom base includes an input device.

7. The supporting component according to claim 6, wherein the input device is a keyboard.

8. The supporting component according to claim 1, wherein the supporting plate includes an extending portion, when the top base is at the closing position, part of the bottom base and the top base are between the extending portion and the supporting plate, and the supporting unit is pivottably connected to the extending portion by the third pivot.

9. The supporting component according to claim 1, wherein the supporting unit comprises a first supporting unit and a second supporting unit, the first supporting unit is pivottably connected to the second supporting unit by a fourth pivot, the first supporting unit is pivottably connected to the top base by the second pivot, the second supporting unit is pivottably connected to the bottom base by the third pivot, when the top base pivots around the first pivot from the closing position to the opening position, the top base pushes the first supporting unit so that the second supporting unit pushes the supporting plate sticks out from the accommodating groove along the drawing direction.

10. The supporting component according to claim 9, wherein the fourth pivot moves toward the supporting plate so as to bend the included angle between the first supporting unit and the second supporting.
